(19) United States
(12) Patent Application Publication
(10) Pub. No.: US 2004/0182112 A1
(43) Pub. Date: Sep. 23, 2004

(54) Conveyance apparatus, a manufacturing apparatus of an optical element, and a manufacturing method of the optical element

(75) Inventor: Shigeru Hosoe, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/765,101

(22) Filed: Jan. 28, 2004

(30) Foreign Application Priority Data
Jan. 31, 2003 (JP) JP2003-024356

(51) Int. Cl. C03B 40/02

(52) U.S. Cl. 65/25.1; 65/162; 65/170; 65/29.21

(57) ABSTRACT

A conveyance apparatus, including:

a supporting device having a through hole passing in a gravity direction, to support a glass material in a fluid or semi-fluid condition; and

a supplying device to supply a fluid into the through hole;

wherein when the glass material is dropped into the through hole, it is supported by the fluid in the through hole, under a non-physical contact condition, and when the glass material is not supported by change of the force of the fluid, it drops from a lower end of the through hole to an outside.

### BACKGROUND OF THE INVENTION

The present invention relates to a conveyance apparatus which is suitable for conveying a load such as a material for molding, without being physical contact, a manufacturing apparatus of an optical element, and a manufacturing method of that optical element.

In cases that a glass material is employed and an optical element is press-molded, there are two supplying methods of the glass material, one of which is that a spherical glass material called a pre-form is supplied to a molding die, while the other method is one in that a heat-melted glass material is stored and a tiny fraction of the material is picked up and is supplied discontinuously to the molding die. Concerning the latter method, the glass is in a melted condition and is dropped down from a nozzle, as disclosed in patent document 1, or the glass material is cut by a cutter to an adequate dose having an optional volume, and which is then supplied to the molding die, as disclosed in patent document 2.

When the pre-form as mentioned in the former method is supplied, since it is possible to supply the glass element which has been formed more precisely, the pre-form is more suitable for molding a precise optical element. However, since the pre-form is formed from a glass element one by one, the problems are that it is generally more expensive, and it is necessary to prepare space to individually store the perform.

That is, from the point of view of cost reduction, required is technology wherein a tiny fraction of the glass material is sequentially picked up from the heated and melted glass material, and that tiny fraction is formed to a high precision shape before the press molding and then the tiny fraction becomes a solidified material. In this case, the solidified material is in a condition in which the degree of viscosity is more than 10⁵ pois, and at a condition in which it takes a long time for the form to change itself by viscous flow.

[Patent document 1]

JAPANESE TOKKAISHOU 62-270423

[Patent document 2]

JAPANESE TOKKAISYOU 63-162539

[Patent document 3]

JAPANESE TOKKAIHEI 8-133758

In cases when the glass material is supplied by the method described in the latter case, when the optical element is formed, the glass material is heated and melted to the flowing condition. In order to obtain an adequate formation and the life of the die, before the glass material is injected into a pair of molding die, it is ordinarily necessary to wait until the glass material is cooled down to a specific molding temperature that is near its softening point. A problem, however, is how to hold the glass material in this condition.

Further, when the glass material is injected, and when its center is not in the center of the optical transferring surface of the molding die, and then when the press formation is performed, the optical transferring surface is not evenly pressed, resulting in an eccentrically transferred optical surface of the optical element. If such a problem happens when the molded article is the optical element, astigmatism or coma is generated in the molded optical element, whereby it is not possible to obtain highly accurate optical characteristics. Therefore, the technology for setting the glass material into the center of the molding die is very important to perform high precision press molding. However, in the above-mentioned conventional example, there is a problem in that the glass material is difficult to be injected into the correct position in the molding die, while keeping the glass material in a condition suitable for molding. For example, a contacting guide is disclosed in patent document 1, and this guide functions so that a dropped melted glass material is contacted and rotated on a surface of the guide, and thereby, the glass material is injected onto the center of the molding die. However, the melted glass material at a high temperature is extremely chemically active, for example, the glass material bonds and adheres to the surface of the guide, or the surface of the guide which the glass material touches separates and enters into the glass material, resulting in stained glass material.

When the glass material in the melting condition is cut by the cutter of the above-mentioned latter method, the cut surface separated from the glass material in a nozzle is not smooth, and a discontinuous cut surface appears immediately after the cut. The cut surface can be smoothened after passage of a long time in a heating and melting situation, but once the glass material is cut, it drops freely and is rapidly cooled down, so that there is no time for the glass material to change its shape to a nearly spherical state which is usually caused by a change of surface tension while dropping, and thereby the glass material may be solidified having the abnormal discontinuous cut surface. When the abnormal shaped glass material is press-molded, uniform pressure cannot be distributed on all of the material, resulting in a situation in which the form of the molding die cannot be precisely transferred to the glass material. That is, in order to precisely perform the transformation of the form from the molding die to the glass material, it is desirable that when the glass material is injected into the molding die, the shape of the glass material has already been pre-formed to some degree.

In order to form the melted glass material to a nearly spherical shape, it is necessary that the melted glass material is at a high temperature at which the degree of viscosity is so low that the melted glass material can adequately change its form due to the surface tension, with enough flowing time for the melted glass material. However, if the above-mentioned formation is performed during vertical free-fall, it is necessary to provide at least several meters of vertical free-fall distance, and further, it is necessary to employ a cooling distance and a falling speed reduction distance in which the glass material is solidified and received without shock, which mean that an extraordinary long and vertical cylindrical furnace is necessary. Since there is restricted installation spaces for such a long cylindrical furnace, and further, since there are many high temperature portions in the cylindrical furnace, it is not possible to precisely and independently adjust the temperature in its falling path through the cylindrical furnace, due to convection generated by the vertical interval, which is not practical.

On the other hand, from the view point of performing effective press-molding, it is ideal that the melting of the glass material, the shape formation, and the press-molding can be a continuous process. Specifically, in the method in which the pre-form is supplied into the molding die by the above-mentioned former method, described relating to conventional technology, the process is divided into a process for forming the shape of the glass material, and producing the pre-form through cooling/solidifying, and a process for heating and softening the pre-form to the level of the above-mentioned degree of viscosity of 10⁵-10⁸, and then performing the press-molding. Accordingly, the glass material is cooled down to an ambient room temperature when the pre-form is produced, and then the pre-form is again heated to perform the press-molding, which is a wasteful process of heating and processing.

From the above-mentioned respects, the following are the prospect of technology wherein the melted glass material is ejected from the melting furnace into the molding die, and an effectively molded article is produced. In order to drop the melted glass material from a nozzle, it is necessary that the glass material is melted to a degree of viscosity of 10⁰-10⁴ pois, which is obtained when the temperature of the glass material for general optical elements is about 800-1000° C. However, when the glass material is press-molded and produced as an optical element at such high temperature, the glass material can flow into the molding die so rapidly that the glass material cannot be pressed with high pressure onto the optical transferring surface of the molding die, resulting in very poor transfer from the optical surface of the molding die to the surface of the optical element. Further, the temperature difference between the fluid condition and the cooled/hardened condition is so great that the amount of shrinkage caused by the cooling of the glass material is excessive, which generates shrinkage cavities or creases on the molded optical surface. Still further, when the glass material at high temperature comes into contact with the optical transferring surface of the molding die, the optical transferring surface of the molding die is ruined, or creates a fusion bond with the glass material, resulting in shortening the life of the molding die. The mirror finish of the optical surface of the molded and transferred optical element deteriorates resulting in a great number of small pits on the optical surface, resulting in an extraordinary reduction of the desired optical characteristics. Accordingly, for the press-molding formation, in order to obtain precise transferability of the optical surface, and long life of the molding die, and to prevent a fusion bonding, it is preferable that the temperature of the glass material is as low as possible, and the shape of the glass material must be easily changed by the pressing pressure at this temperature, and it is also important that a degree of viscosity at this temperature is obtained which is suitable for the precise transfer of the optical surface of the optical element, and further, it is desirable that the degree of the above-mentioned viscosity is reproducibly obtained when the molding is performed. The degree of viscosity for the molding is about 10⁵-10⁸ pois, and the degree of viscosity is inseparably related to the temperature so that the temperature of the glass material having the above-mentioned degree of viscosity is approximately the softening point of the glass material. That is, glass material at about 1000° C. is dropped, and it is received and held, after which its shape is formed, and when the formed glass material is thrown into the molding die, it is preferable that the glass material is cooled to the desired molding temperature which is near the softening point. Further, since heat conductivity of the glass material is very low, therefore, if the cooling slope of the glass material is not optimal, the temperature difference between the interior and the surface can be large, and as a result the degree of viscosity between the interior and the surface of the glass material differs, and thereby, the press molding process can not proceed uniformly, resulting in deterioration of the transferability of the molding. Accordingly, in the manufacturing technology of the optical element, it is very important to precisely control the cooling slope of the glass material.

As mentioned above, there are several problems to be noticed in the technology by which melted glass material is injected from a furnace to the molding die, and by which molded products are continuously and precisely produced.

When molded is an optical element of very small diameter, for example, less than 5 mm, the dropped liquid glass material is so small that diameter of a nozzle for dropping the glass is also small. In order to drop the melted glass material, the temperature of the melted glass material in the nozzle must preferably be controlled to be so high that the degree of viscosity of the melted glass material is adequately small. Further the dropped glass material is a small volume and its thermal capacity is so small that the glass material is easily affected by the environment, and the temperature of the glass material easily and quickly changes, which means that temperature control with the high repeatability and high stability is very difficult. If the temperature of the glass material is not stable, the temperature at the contacting portions between the molding die and the glass material itself becomes unstable in the press-molding process, then the melted glass material is fusion-bonded to the optical transfer surface of the molding die, and not only the shape accuracy of the formed optical element is deteriorated, but the life of the molding die is also shortened, which results in stoppage of the manufacturing process to change the molding die, resulting in the increase of the production-cost, which in turn have a significant effect on the manufacturing process. Still further, since the temperature and the degree of viscosity of the melted glass material are so closely related to each other, when the temperature is not stable and the same temperature can not obtained repeatedly, the stability and the repeatability of the press condition for the press-molding is deteriorated, which seriously and adversely affects the extremely precise and high yield press-molding.

As can be understood from the above description, in order to produce optical elements of very small diameters, the temperature of the liquid melted glass material at a small volume must be controlled very precisely, compared to cases in normal optical elements having a large volume, and for which it is preferable to also perform press-molding at high stability, high precision and high yield.

Concerning low Tg glass whose glass transition point Tg is less than 400° C., the lower the glass transition point, the smaller the difference between the transition point and the softening point, which results in a narrower molding tolerance level for performing the press-molding near the softening point. Therefore, when low Tg glass is used for the glass material, it is necessary to more precisely perform temperature control of the press-molding of low Tg glass material more precisely than normal glass material, and which is very important for realizing precise press-molding with high yield.

Accordingly, the critical matters required for temperature control of the melted glass material in a droplet condition are the case of a small volume and the case of low Tg glass, and especially when the low Tg glass of a small volume which satisfies both cases is employed, still higher precision is required. It was impossible to repeatedly perform stable press-molding by conventional technology.

### SUMMARY OF THE INVENTION

By re-examination of the conveyance technology and manufacturing technology from a different view point, the objective of the present invention is to provide a conveyance apparatus, a manufacturing apparatus of an optical element, and a molding method of the optical element wherein a fluid state or a semi-fluid state glass material is supported by a fluid, and is precisely ejected into a desired position.

Further, the objective of the present invention is to provide a molten glass conveyance apparatus, a manufacturing apparatus of the optical element, and a molding method of the optical element by which the glass material melted at a high temperature of approximately 1000° C. is supported, and which can cool the glass material to an applicable temperature for the shape forming process.

Still further, the objective of the present invention is to provide a conveyance apparatus, a manufacturing apparatus of the optical element, and a molding method of the optical element which results in a stable press-molding condition, and can produce a pressed production of high quality and low cost, using a high precision and high efficiency press-molding.

The objectives of the present invention can be attained by any one of the structures described below.

Structure 1.

A conveyance system, including:

a supporting means for supporting a molten glass material in a through hole, in cases when a fluid or semi-fluid molten glass material is injected from top into the through hole which penetrates from the top in a vertical direction, and

a supplying means for supplying a fluid into the through hole,

wherein the fluid, supplied from the supplying means, supports the glass material, in such a condition that the glass material is prevented from coming into contact with any solid portion of the holding means, and wherein when the supporting means stops support of the glass material, the glass material is ejected downward from the through hole to the exterior. Accordingly, even when the glass material has been heated and melted, the supporting means can support the glass material by the fluid in a non solid contact condition, and the supporting means does not come into contact with the molten glass material, therefore, it is possible to obtain a long life of the supporting means, and also to prevent the glass material from catching a foreign material. Further, by deciding a position of the through hole, it is possible to direct the molten glass material in an exact position between paired molding dies. Specifically, in a case of a small voluminal glass material for a small sized optical element, the glass material is so small that it is very difficult to support the glass material in a non-physical contact floating condition by conventional methods. However the fluid employed in the present invention makes it possible to stably support the molten glass material, while positioning the glass material in the center of the through hole of the supporting means. In this case “a fluid or semi-fluid” means a condition in which the glass material is heated and melted. The present invention includes a case wherein a portion of the molding dies can move from an injecting position, located under the through hole, to eject the glass material, to a molding position, below the through hole, to affect molding of the glass material.

In an apparatus disclosed in patent document 3 disclosing a non solid contact conveyance technology, employed is a method wherein a jig, functioning to support the glass material, is divided into two pieces so that the glass material falls, but in which the falling position is not stably determined, and thereby it is very difficult to exactly eject the glass material into the center of the molding die. On the other hand, the present invention determines the position of the through hole toward the molding die, and thereby, can precisely direct the glass material into the molding die.

Structure 2.

The conveyance apparatus in structure 1, wherein the fluid supplied from the supplying means comes into contact with the glass material, and thereby, the temperature of the glass material can be controlled. Accordingly, while supporting the heated and fluid or semi-fluid glass material by the supporting means, the glass material can be cooled (or heated) to the suitable temperature in the course of supporting by the supporting member, by which more appropriate molding can be performed.

Further, the supporting means floats and rotates the glass material as a load, and the surface of the glass material comes evenly into contact with the fluid, due to receiving the jetting power of the fluid, and the supporting means can thus form a softened material into a nearly spherical shape. In the case of the small sized glass material for the small diameter optical element, the thermal capacity is so low that the temperature of the glass material easily changes due to minute environmental variation. It is very difficult to precisely control and keep the softening temperature by conventional methods, however, the present invention can control the temperature by allowing the fluid to uniformly come into contact with the molten glass material, it is possible to very precisely and evenly maintain the temperature of the molten glass material to the required temperature. For example, in the case of low Tg glass, the degree of viscosity changes over a wide range due to temperature, but in the present invention, the fluid controls the temperature of the glass material very precisely and evenly, resulting in repeatedly obtaining the required degree of viscosity.

Structure 3.

The conveyance apparatus in structure 1 or 2, further including temperature control means for controlling the temperature of the fluid supplied to the through hole. Accordingly, it is possible to control the temperature of the glass material to a desired temperature.

Structure 4.

The conveyance apparatus in structure 3, wherein the temperature control means has a heater and a thermal sensor which are arranged in the supplying path of the fluid. Accordingly, it is possible to control the temperature of the fluid more precisely using such heater and the thermal sensor.

Structure 5.

The conveyance apparatus in any one of structures 1-4, wherein the fluid is supplied into the through hole in such a way that the fluid passes between the glass material and the interior wall of the through hole. Accordingly, it is possible to securely support the glass material in a non solid contact condition.

Structure 6.

The conveyance apparatus in any one of structures 1-5, further includes shutter member, which is located lower in the vertical direction than the position through which the fluid is supplied into the through hole, and a shutter member which can move from a position for closing at least a portion of the through hole, to a position for opening the through hole. In this structure, it is possible to eject the contained molten glass material from the bottom of the through hole to the exterior, by reducing or clearing away the supplied fluid amount, that is, by narrowing or closing an external valve. If the bottom of the through hole is always open, the fluid flows up to float the glass material, but also flows downward, resulting in reduced inner pressure of the through hole. In order to adequately support the molten glass material, a larger amount of fluid must be supplied. Due to this, there is a drawback, being an increase of used fluid and a corresponding cost increase, by using a pump having more pumping power. Even when the valve is operated and stopped, the remaining fluid pressure in the pipe toward the supporting means is high, and the supply of the fluid to support the molten glass material is not immediately stopped. As a result, problems occur wherein timing to stop support of the molten glass material is not stable (meaning timing for ejecting the glass material into the molding die), and wherein the position of the ejected glass material into the molding die becomes unstable, or the glass material is blown away, due to the extraordinary amount of fluid flowing downward from the through hole. To overcome these problems, by opening/closing of an installed shutter, the amount of fluid flowing toward the molten glass material is rapidly controlled. Firstly the shutter member is positioned in a closed position, and the glass material is supported, next when the through hole is positioned at a place where is suitable for throwing the molten glass material, the shutter is moved to an opened position, then the glass material can be thrown in an adequate timing, and further the amount of the supplying fluid is largely cut down. “Opened position” includes not only the condition in which the through hole is totally open, but also the condition in which the through hole is partly open, and in this case, the opening area in the opened position is larger than the opening area in the “closed position”.

Specifically, when the glass material is small such as the one for a small diameter optical glass element, the weight is very small, less than one gram, therefore, it is not possible to precisely throw the glass material into the predetermined position in the molding die by the conventional method, however it is possible to direct the small molten glass material to a predetermined position which is determined by the through hole of the supporting means, that is, to precisely direct the small molten glass material into the predetermined position in the molding die. Due to this, the press-molding condition is stabilized, and subsequent potential astigmatism and coma are controlled which result from poor positioning of the molten glass material into the predetermined position in the molding die, and further, optical elements having superior optical characteristics are precisely produced with high yield, and still further, high productivity of optical elements is realized at lower cost.

Structure 7.

The conveyance apparatus in any one of structures 1-6, wherein the glass material is optical glass. “Optical glass” means a glass material having excellent optical characteristics and used for forming optical elements.

Structure 8.

The conveyance apparatus in any one of structures 1-7, wherein the temperature of the fluid supplied into the through hole is lower than the temperature of the glass material at the moment when the glass material is injected into the through hole, and higher than the transition point of the glass. Due to this, the glass material is cooled in the course of the conveyance. By optionally controlling the temperature of the supplied fluid, that is, controlling the temperature of the fluid to be lower than the temperature of the glass material, it is possible to realize a cooling function having a very precise and repeatable thermal slope. As mentioned above, since the fluid uniformly comes into contact with the glass material and flows around the glass material, if the temperature of the fluid can be precisely controlled, the temperature of the surface of the glass material is directly also controlled. Accordingly the cooling slope on the surface of the glass material is optimized by counting on the delay due to a heat diffusion from the interior, therefore, very precise control of the surface of the molten glass material can be performed. Specifically in the case of low Tg glass, lower than 400° C., the amount of change in the degree of viscosity due to temperature change is large, but it is possible to precisely cool the low Tg glass to the desired temperature via the present invention. Therefore, it is possible to repeatedly obtain the desired degree of viscosity, and to stably perform press-molding.

Structure 9.

The conveyance apparatus in structure 8, wherein when the glass material is dropped, the temperature of the fluid supplied into the hole is set higher than the softening point of the glass material, and after that, the temperature of the fluid is set lower than the softening point plus 100° C., and is always higher than the transition point of the glass material. Specifically, if the fluid is a gas, the thermal capacity of the gas is so low that the temperature of the gas can easily be changed, and the temperature of the molten glass material can be rapidly adjusted. Further, the molding temperature of the glass material is ordinarily near the softening point. However it takes several seconds from the moment when the glass material is thrown into the molding die from the conveyance apparatus, to the moment when the press-molding is actually performed. When the temperature of the molding die is set lower than the softening point, the temperature of the molten glass material drops rapidly by the thermal conduction during several seconds or less. In the present invention, when the molten glass material is thrown into the molding die, since the temperature of the fluid is set higher than the softening point of the glass material, the glass material is precisely formed, and after that, the fluid is reheated to the softening point plus 100° C., and accordingly, when the temperature of the molding die is set lower than the softening point, the temperature of the molten glass material in the actual press-molding process can be accurately adjusted.

Structure 10.

The conveyance apparatus in structure 8, wherein the temperature of the fluid supplied into the through hole is set lower than the softening point of the glass material plus 100° C., and is always higher than the transition point. Therefore, the temperature of the thrown molten glass material is adjusted so precisely that the optical element can be formed very precisely.

Structure 11.

The conveyance apparatus in any one of structures 1-10, wherein the glass material ejected from the conveyance apparatus is supplied to the molding die of a molding device, and thereby, the optical element can be formed very precisely.

Structure 12.

The conveyance apparatus in structure 11, wherein the glass material is shaped by the molding die of the molding device, and becomes a very precise optical element.

Structure 13.

The conveyance apparatus in any one of structures 1-12, wherein the volume of the glass material to be thrown is less than 100 mm³. The effect of the present invention is brought out more effectively for glass material of such a small volume. It was very difficult to form glass material to be a spherical shape, because the heated and melted glass material at such a small volume for a small diameter optical element is caught in the ambient temperature, the temperature of the melted glass falls rapidly, and the degree of viscosity becomes greater. By use of the present invention, however, the glass material is heated while floating, and the glass material is randomly rotated by the viscous friction between the fluid (a gas for example) and the glass material, and therefore the glass material is uniformly controlled to the melting temperature. Further, a blow-up pressure of the fluid is applied all over onto the surface of the glass material by the rotation of the glass material, and therefore the glass material can be accurately formed to be a spherical shape.

Structure 14.

The conveyance apparatus in any one of structures 1-13, wherein the glass transition point of the glass material is less than 400° C.

Structure 15.

The conveyance apparatus in any one of structures 1-14, wherein a tapered section whose diameter becomes greater toward the top is provided at the top section of the through hole. The dropped glass material can be easily received by the tapered section.

Structure 16.

The conveyance apparatus in any one of structures 1-15, wherein a porous material is arranged on at least a portion of the inner circumferential surface of the through hole, through which the fluid is supplied to the through hole. The fluid can be preferably supplied by an even pressure through an infinite number of holes in the porous material. However, it is not limited to porous material, but it is possible to supply the fluid through a plurality of holes on the inner circumferential surface of the through hole.

Structure 17.

The conveyance apparatus in structure 16, wherein the porous material is a graphite which has low affinity for the glass material. However, it is also possible to use porous ceramics such as silicon nitrode, alumina, and carbon silicide.

Structure 18.

A manufacturing apparatus of the optical element, including:

a supporting means for supporting a glass material in a through hole, in cases when a fluid or semi-fluid molten glass material is injected from above into the through hole which penetrates from the top in a vertical direction;

a fluid supplying device to supply a fluid into the through hole; and

paired molding dies, one of which can perform relative displacement with the other between a receptive position in which both of the dies are separated and an adjacent position at which the glass material can be molded; wherein the fluid, supplied from the supplying means, supports the glass material, in such a condition that the glass material is prevented from coming into contact with any solid portion of the holding means, and wherein when the supporting means stops support of the glass material, the glass material is ejected downward from the through hole into one of the paired molding dies in the receptive position, and then the glass material is molded and formed to be an optical element. The function and the effect of this structure are the same as those of structure 1.

Structure 19.

The manufacturing apparatus of the optical element in structure 18, wherein the fluid, supplied from the supplying means, comes into contact with the glass material, and thereby the fluid controls the temperature of the glass material. The function and the effect of this structure are the same as those of structure 2.

Structure 20.

The manufacturing apparatus of the optical element in structure 18 or 19, further including a temperature control means for controlling the temperature of the fluid which is supplied into the thorough hole. The function and the effect of this structure are the same as those of structure 3.

Structure 21.

The manufacturing apparatus of the optical element in structure 20, further including a heater and a thermal sensor, which are arranged in a fluid supplying path. The function and the effect of this structure are the same as those of structure 4.

Structure 22.

The manufacturing apparatus of the optical element in any one of structures 18-21, wherein the fluid is supplied into the through hole so that the fluid passes between the glass material and the inner circumferential surface of the through hole. The function and the effect of this structure are the same as those of structure 5.

Structure 23.

The manufacturing apparatus of the optical element in any one of structures 18-22, further including a shutter member which can move between a closing position to close a portion of the through hole and an opening position which opens the through hole, vertically below a region in the through hole at which the fluid is supplied. The function and the effect of this structure are the same as those of structure 6.

Structure 24.

The manufacturing apparatus of the optical element in any one of structures 18-23, wherein the glass material is an optical glass.

Structure 25.

The manufacturing apparatus of the optical element in any one of structures 18-24, wherein the temperature of the fluid, supplied in the through hole, is lower than the temperature of the glass material at the time when the glass material is dropped, and higher than the glass transition point. The function and the effect of this structure are the same as those of structure 8.

Structure 26.

The manufacturing apparatus of the optical element in structure 25, wherein the temperature of the fluid, supplied to the through hole, is set higher than the softening point of the glass material, and after that, is set lower than the softening point of the glass material plus 100° C., and is always higher than the transition point of the glass material. The function and the effect of this structure are the same as those of structure 9.

Structure 27.

The manufacturing apparatus of the optical element in structure 25, wherein the temperature of the fluid, supplied to the through hole, is set lower than the softening point of the glass material plus 100° C., and is always higher than the transition point of the glass material. The function and the effect of this structure are the same as those of structure 10.

Structure 28.

The manufacturing apparatus of the optical element in any one of structures 18-27, wherein the volume of the glass material to be thrown is less than 100 mm³. The function and the effect of this structure are the same as those of structure 13.

Structure 29.

The manufacturing apparatus of the optical element in any one of structures 18-28, wherein the transition point of the glass material is less than 400° C. The function and the effect of this structure are the same as those of structure 14.

Structure 30.

The manufacturing apparatus of the optical element in any one of structures 18-29, wherein on the top section of the through hole, provided is the tapered wall section which increases in diameter from its base to its top. The function and the effect of this structure are the same as those of structure 15.

Structure 31.

The manufacturing apparatus of the optical element in any one of structures 18-30, wherein at least on the portion of the inner circumferential surface of the through hole, arranged is the porous material, through which the fluid is supplied into the through hole. The function and the effect of this structure are the same as those of structure 16.

Structure 32.

The manufacturing apparatus of the optical element in structure 31, wherein the porous material is a graphite. The function and the effect of this structure are the same as those of structure 17.

Structure 33.

A manufacturing method of an optical element, including:

a step of vertically dropping a glass material being heated and in the fluid or semi-fluid condition into a through hole of a supporting means which is vertically extending from the top;

a step of supplying a fluid into the through hole by a supplying means;

a step of supporting the dropped glass material against the force of gravity, under a non-physical-contact except for the fluid which is supplied into the through hole;

a step of dropping the glass material into a molding die from a gravitational end of the through hole, when the supply of the fluid is stopped, or the amount of supply of the fluid is reduced; and

a step of forming the dropped glass material into an optical element by the molding dies. The function and the effect of this structure are the same as those of structure 1.

Structure 34.

The manufacturing method of the optical element in structure 33, further including a step of controlling the temperature of the fluid supplied by the supplying means, wherein the fluid supplied into the through hole comes into contact with the glass material, and thereby the temperature of the glass material is controlled. The function and the effect of this structure are the same as those of structure 2.

Structure 35.

The manufacturing method of the optical element in structure 34, wherein, the temperature of the glass material when the glass material is thrown into the through hole, is higher than the temperature of the glass material when the glass material is ejected into the molding die. In the present invention, by using the fluid supplied into the through hole, it is possible to adequately cool the glass material dropped into the through hole.

### BRIEF DESCRIPTION OF THE DRAWINGS

FIG. 1 is a sectional view of a conveyance device of an embodiment of the present invention.

FIG. 2 is a sectional view of a variation of a conveyance device of an embodiment of the present invention.

FIG. 3 is a sectional view of another variation of a conveyance device of an embodiment of the present invention.

FIG. 4 is an enlarged sectional view showing molding dies and their circumference in a molding device, and a conveyance device.

FIG. 5 is a sectional view of a conveyance device of a second embodiment of the present invention.

FIG. 6 is a sectional view taken on line VI-VI of the conveyance device shown in FIG. 5.

FIG. 7 is a sectional view of a conveyance system of an embodiment of the present invention.

FIG. 8 is a sectional view of a conveyance device of a second embodiment of the present invention.

FIG. 9 is a sectional view of a variation of a conveyance device.

FIG. 10 is a sectional view showing the details of the tapered wall sections of the through hole.

### DETAILED DESCRIPTION OF THE DRAWING

The preferred embodiment of the present invention will be described while referring to the drawings.

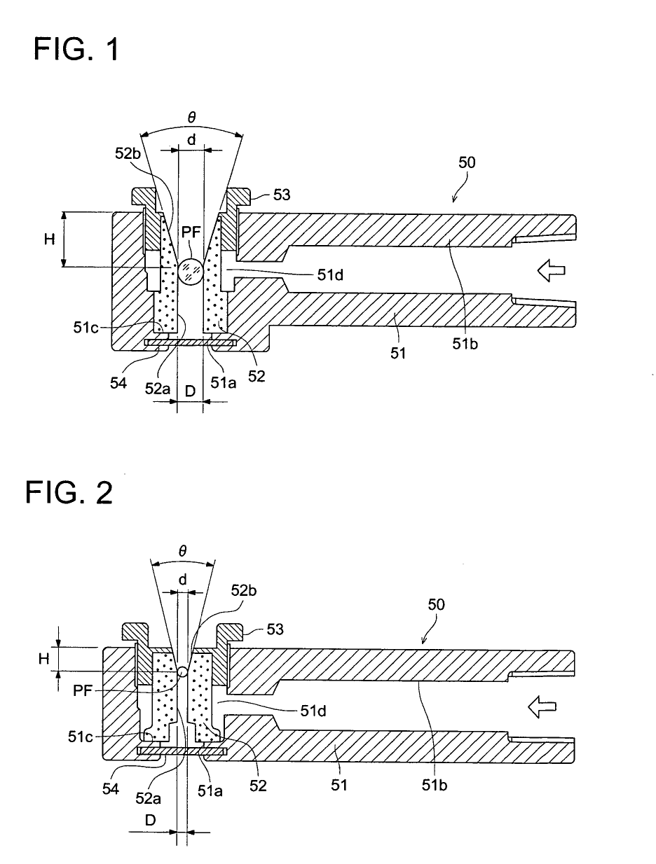

FIG. 1 is a sectional view of a conveyance device of the first embodiment; In this embodiment, the load is represented by a glass material which is a material for an optical element, however, it is not limited to this, a plastic is also acceptable. The vertical direction is the same as the gravity direction in FIGS. 1-5, 7 and 8.

As shown in FIG. 1, conveyance device 50 is provided with:

conveyance arm 51 which is driven three-dimensionally by a driving device not-illustrated;

supporting cylinder 52 included in through hole 51a which is arranged vertically in the figure at the top section (left end) of conveyance arm 51,

fixing member 53 which secures supporting cylinder 52; and

shutter member 54 which is arranged near the lower end of through hole 51a, and can be driven by an actuator not-illustrated, between a closing position where through hole 51a is closed and a opening position where through hole 51a is not closed.

Conduit 51b, which exists inside conveyance arm 51, is arranged along the long axis of conveyance arm 51, and is connected to through hole 51a. The lower end of supporting cylinder 52 formed of porous material (in this case, graphite) comes into contact with stepped section 51c formed near the lower end of through hole 51a of conveyance arm 51, while the periphery section at the top end of supporting cylinder 52 is fitted to fixing member 53. Accordingly, fixing member 53 is screwed on through hole 51a from the top so that the top end and the lower end of supporting cylinder 52 are fitted to through hole 51a in a sealed condition. Further, annular space 51d is formed between the central periphery of supporting cylinder 52 and the inside of through hole 51a.

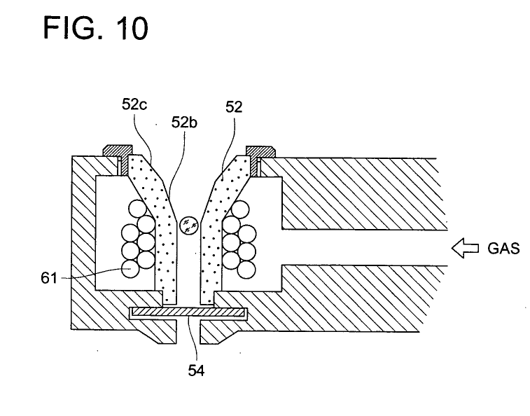

Straight wall section 52a is formed at the lower end of the inner surface of supporting cylinder 52, and tapered wall section 52b which increases in diameter from its base to its top, is formed at the top end of the inner surface of supporting cylinder 52. Taper angle θ of tapered wall section 52b is 30 degrees in the present embodiment. Further, in the present embodiment, when diameter d of glass material PF which is to be supported, is 7.2 mm, it is preferable that the inside diameter D of straight wall section 52a is 7.4 mm, and height H of tapered wall section 52b is 0.2d-2.0d. As shown in FIG. 10, top-most tapered wall section 52c whose taper angle is greater than taper angle θ of tapered wall section 52b, is formed at the top end of supporting cylinder 52, so that it can more easily receive molten glass material PF which is dropped from the top. Further, the supplied gas is diffused so generously that the gas easily supports glass material PF. Here, conveyance arm 51 and supporting cylinder 52 structure the glass material supporting means, while the porous surface of supporting cylinder 52 structures a gas supplying means. Further, straight wall section 52a of supporting cylinder 52 and tapered wall section 52b structure the vertical through hole.

FIG. 2 shows a variation of the conveyance device of the present embodiment, in which only the sizes of each section are different from those shown in FIG. 1, therefore, the same symbols and numbers as those of the embodiment shown in FIG. 1 are used, and the associated explanation is therefore not repeated. In the present variation, taper angle θ of tapered wall section 52b is also 30 degrees, When diameter d of glass material PF which is to be supported, is 2.6 mm, it is preferable that inside diameter D of straight wall section 52a is 2.8 mm, and height H of tapered wall section 52b is 0.2d-2.0d.

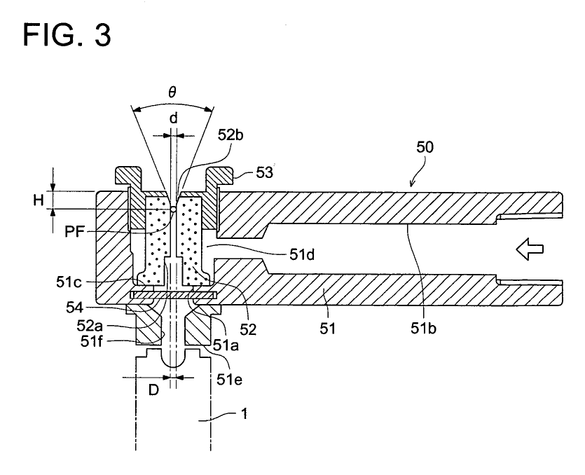

FIG. 3 shows another variation of the conveyance device of the present embodiment, only the sizes of each section except for extended structure 51e provided at the lower end of the through hole are different from those shown in FIG. 1, therefore, the same symbol and numbers as those of the embodiment shown in FIG. 1 are used, and the associated explanation is not repeated. Cylindrical extended structure 51e is arranged at the lower side of the top of conveyance arm 51, and has penetrating hole 51f which is coaxial to straight wall section 52a. When glass material PF is dropped downward from straight wall section 52a, glass material PF is apt to hit and rebound from lower molding die located below straight wall section 52a, or apt to be blown away and ejected out by the fluid which blows out below straight wall section 52a. These phenomena easily occur when the glass material is very small. Therefore, in order to prevent glass material from being ejected from lower molding die 1, the present variation provides extended structure 51e between conveyance arm 51 and lower molding die 1. In the present variation, taper angle θ of tapered wall section 52b is 30 degrees. When diameter d of glass material PF which is to be supported, is 1.2 mm, it is preferable that inside diameter D of straight wall section 52a is 1.4 mm, and height H of tapered wall section 52b is 0.2d-2.0d.

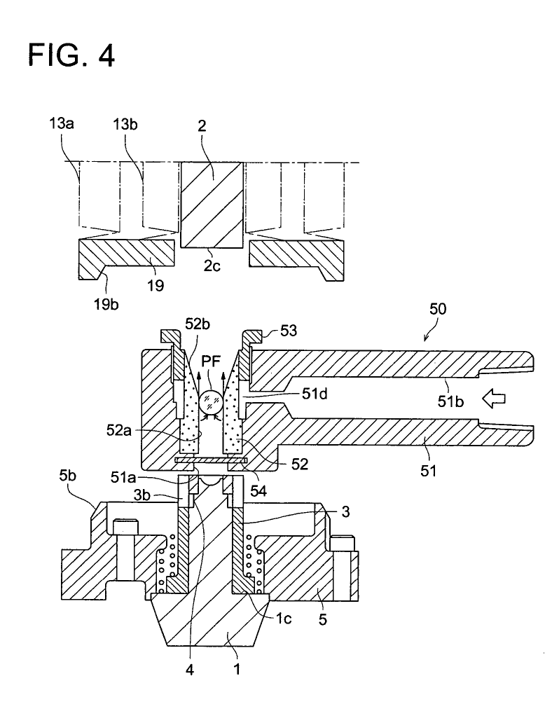

Next, the operation of conveyance device 50 will be described. FIG. 4 is an enlarged section showing the circumference of the molding dies of the molding device and also showing the conveyance device. In this case, it is also possible to describe that the molding device of the present invention is composed of conveyance device 50, and molding dies 1 and 2. Firstly, conveyance device 50 receives dropped glass material PF in supporting cylinder 52, at a glass material supplying position which is not illustrated, but will be described later. In this case, the conveyance device has shutter member 54 which is in the closed position, and features heated and dried nitrogen gas as the fluid (the nitrogen concentration of which is to be greater than 60 mol %) pressurized from the outside by high pressure into conduit 51b, whereby the heated and dried nitrogen gas is forced uniformly from the entire inner circumferential surface of supporting cylinder 52, which is a porous material, through annular space 51d (being a step of supplying the fluid), and thereby, glass material PF can be floated and supported under a non-physical contact condition (being a step of supporting the glass material). In this case, the inner top section of supporting cylinder 52 is formed of tapered wall section 52b, so that glass material PF can be supported stably at the border between straight wall section 52a and tapered wall section 52b, where the pressure changes suddenly.

In this case, since the dried nitrogen gas is controlled to be at a predetermined temperature, it is possible to heat the outer surface of glass material PF adequately during conveyance (being a step of heating the load), and further, glass material PF is vibrated and thereby rotated by the dried nitrogen gas so that all surface of glass material PF are heated evenly, and thus supported glass material PF can be at an optimal temperature for molding.

Next, while glass material PF is supported in a floating condition, conveyance arm 51 is moved, so that supporting cylinder 52 is positioned between lower molding die 1 (a lower molding die of the paired molding dies) and upper molding die 2 (an upper molding die of the paired molding dies) of the molding device, whose total shape is not illustrated. After that, shutter member 54 is moved to the opened position by an actuator which is not illustrated, and thereby the pressure of the dried nitrogen gas for supporting glass material PF is reduced and can no longer support glass material PF, after which glass material PF drops and passes through straight wall section 52a of supporting cylinder 52, and thereafter, passes through the lower end of through hole 51a of conveyance device 50 (being a step for throwing the glass material). In this case, since supporting cylinder 52 is formed of porous graphite which is hardly adhered to the molten glass, glass material PF is dropped onto a predetermined position (a position on which the optical axis of the optical transfer surface of lower molding die 1 is aligned with the center of glass material PF) of lower molding die 1, without adhering onto supporting cylinder 52.

After conveyance arm is turned out, the forming operation starts, and lower molding die 1 goes up near upper molding die 2. Further, the nitrogen gas (or air) is pressurized between metal bellows 13a and 13b, which are covering members, from the outside to extend metal bellows 13a and 13b. Tapered surface 19b of touching member 19 moves with the lower end of expanded metal bellows 13a and 13b, and touches tapered surface 5b of fixing member 5, resulting in close contact of tapered surface 5b of fixing member 5 with tapered surface 19b. By this operation, the space surrounding the molding position where glass material PF is placed, is shielded from the circumferential atmosphere. Under the above condition, any remaining nitrogen gas is released from the shielded space by a pump representing a vacuuming means, then the degree of vacuum of the space surrounding the molding dies is reduced to a level of less than 1 KPa. It is preferable that a scroll type vacuum pump is used, because it does not rely on use of an oil, resulting a minimal maintenance and low noise characteristics, which is better for the environment. The time necessary for reducing the pressure is approximately one second.

Further, since glass material PF represents a material to be formed, is cooled during the conveyance beforehand to the required temperature for pressing, as soon as vacuum drawing starts after the dies are covered and sealed, it is possible to allow lower die 1 to move up to start molding (a step for molding). Cylindrical frame 3 is fitted around lower die 1, and when lower die 1 moves up, the top end of frame 3 contacts with standard surface 2c of upper die 2, and the degree of parallelism of standard surfaces 2c and 1c of molding dies 2 and 1 is maintained. After this condition has passed for a few seconds, the nitrogen gas is supplied to the space which is under the reduced pressure around dies 2 and 1, while heater temperature in the dies is controlled so that molding dies 2 and 1 are slowly cooled to the level lower than the transition temperature of glass.

Then the nitrogen gas is exhausted by a pressure control structure not illustrated, from double structured metal bellows 13a and 13b, and metal bellows 13a and 13b contract to force touching member 19 to separate from fixing member 5. By the above procedure, glass material PF is formed to an optical element.

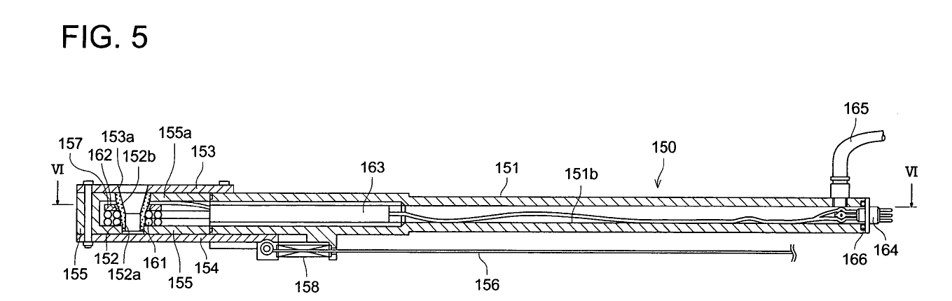

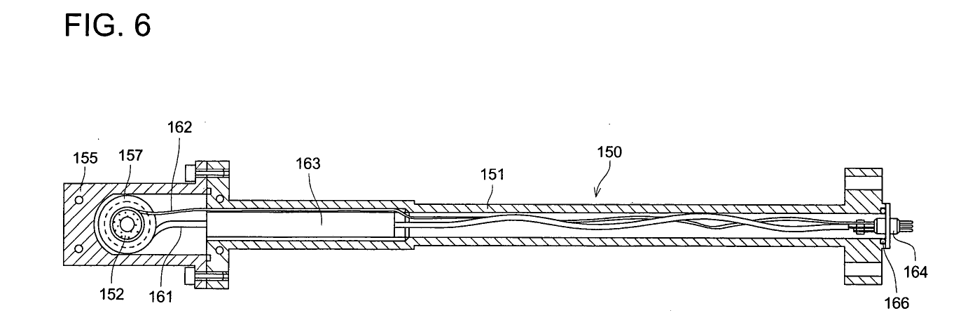

FIG. 5 is a sectional view of the conveyance device of the present embodiment. FIG. 6 is a sectional view taken on line VI-VI of the conveyance device shown in FIG. 5. In FIGS. 5 and 6, conveyance device 150 is provided with;

long and narrow conveyance arm 151 which is driven three-dimensionally by an un-illustrated driving device,

heat-resistant ceramic holder 155, which is arranged at the top end (left end) of conveyance arm 151,

supporting cylinder 152 fitted to through hole 155a which is arranged vertically in the figure of holder 155,

presser plate 153 to hold supporting cylinder 152,

shutter member 154, connected to an un-illustrated actuator by wire 156, and arranged near the lower end of through hole 155a, which moves between a closing position (see FIG. 5) and a releasing position, to close and open through hole 155a, and

ceramic spring 158 made by Zirconia to urge shutter member 154 to the closing position. In the present embodiment, the supporting means is composed of conveyance arm 151, holder 155, and supporting cylinder 152.

On the inner circumferential surface of supporting cylinder 152 formed by a porous material (graphite is used in this embodiment), there are straight wall section 152a having the same diameter which is formed at the lower end of the inner surface of supporting cylinder 152, and tapered wall section 152b which increases in diameter from its base to its top, which is formed at the upper top end of the inner surface of supporting cylinder 152. Sheathed heater 161 used as a heating means, is arranged on the internal center of holder 155 in such a way that they surround straight wall section 152a of supporting cylinder 152, in addition thermostat 162 and heat insulating plate 157 are arranged on the peripheral surface of tapered wall section 152b. Further, heater 163 as a heating means is arranged in conduit 151b. Sheathed heater 161, thermostat 162, and heater 163 which structure a temperature control means arranged in a gas supply route, are connected to electrode 164 attached at the end of conduit 151b, and can be activated electrically from the outside through a not-illustrated connector which is connected to electrode 164.

In the present embodiment, dried nitrogen gas of 0.2 MPa is supplied to conduit 151b through pipe 165 connected to the end of conduit 151b, and is heated to a temperature higher than the normal temperature by heater 163. This temperature is lower than the temperature of the glass material which is immediately after it is dropped. Further the dried nitrogen gas temperature is controlled along the path through the porous material of supporting cylinder 152 which is heated by sheathed heater 161, and thereby the dried nitrogen gas can slowly cool glass material PF while supporting it. The temperature of supporting cylinder 152 is detected by thermostat 162, by which the feedback control of sheathed heater 161 can be achieved.

Since tapered end section 153a, which extends at the same taper angle (or a greater taper angle) from tapered wall section 152b, is formed on presser plate 153 in this embodiment, whereby tapered end section 153a, as well as tapered wall section 152b, can further control spattering of the glass material. Further, since presser plate 153 is formed of high density graphite, even though the glass material PF comes into contact with presser plate 153, it is possible to prevent them from adhering to each other. In the present embodiment, the taper angle is 30 degrees, the maximum diameter of the glass material PF which can be supported, is 7.2 mm, and the inside diameter of straight wall section 152a is 7.5 mm.

The change-over operation of the supporting and dropping of the glass material PF is performed by the closing/opening movement of shutter member 154. Shutter member 154 is activated into the closed position, as shown in FIG. 5, by ceramic spring 158 made by Zirconia that can sustain its elasticity at high temperature, and when wire 156 is pulled to the right side in the figure, shutter member 154 can be moved to the open position against the force of spring 158, and thereby, the floating glass material PF can be dropped.

In the present embodiment, nitrogen gas is supplied under a pressure of 0.2 MPa, which is lower than the stable driving area of the after-mentioned experimental results. This is due to the fact that the thickness of the porous material is set at half of the experimental result, and the part is formed so that the amount of nitrogen gas increases under lowered supplying pressure, and therefore, floating support of the glass material can be achieved at the stable area with margins. Concerning the material of conveyance arm 151, since it is preferable to use one having high heat resistance and nearly the same coefficient of linear expansion as the ceramic material used for holder 155, nobinite cast iron is used. The wirings of sheathed heater 161, heater 163 and thermostat 162 are drawn from the end of conveyance arm 151 to the outside through hermetically sealed electrode 164 for gas-tightness. A connected section between electrode 164 and conveyance arm 151 is sealed by heat-resistance C-ring or heat-resistance O-ring 166 to prevent the supplied nitrogen gas from leaking.

In the same way as for the embodiment mentioned above, in conveyance device 150 of the present embodiment, the nitrogen gas is supplied from fluid supplying pipe 165 through the end section of conveyance arm 151, and is heated by sheathed heater 161, and further ejected from the inside surface of porous supporting cylinder 152, and finally the nitrogen gas supports glass material PF (not illustrated) without being touched in a floating condition. In the above-mentioned procedure, glass material PF rotates or moves in parallel in a floating condition so that the surface of the glass material PF is heated uniformly. Conveyance device 150 conveys glass material PF to the desired predetermined position, and drops it so that the consistent position delivery is performed, as shown in FIG. 5.

Control of the heating temperature of the nitrogen gas is performed in such a way that the temperature of the nitrogen gas is detected by thermostat 162 and electrical current passing through sheathed heater 161 is controlled by a control circuit not illustrated. In order to prevent thermostat 162 from being directly heated by sheathed heater 161 which is coiled around porous supporting cylinder 152, heat insulating plate 157 is arranged between supporting cylinder 152 and sheathed heater 161.

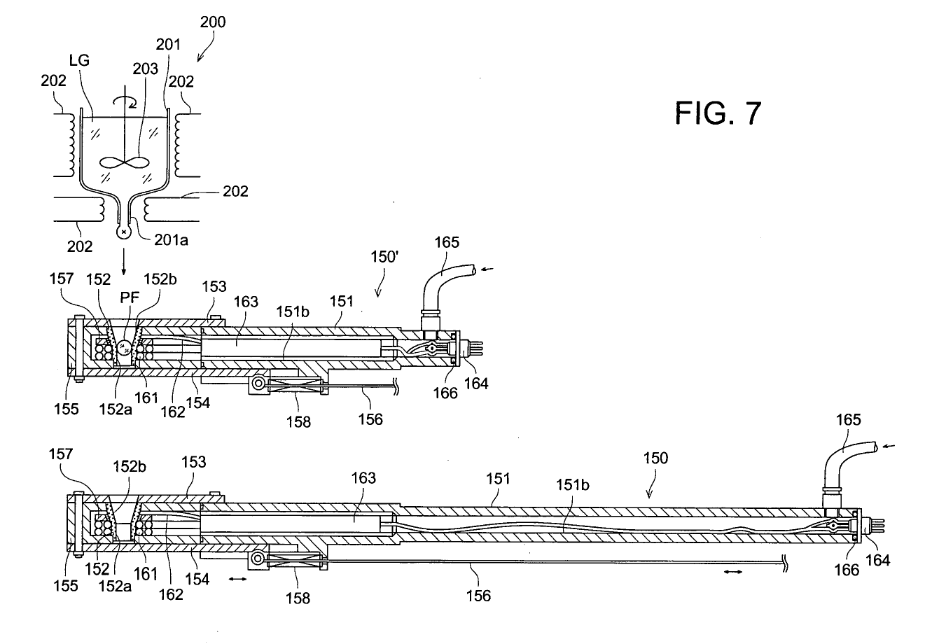

FIG. 7 is a sectional view showing the conveyance system of the present embodiment. The conveyance system is composed of conveyance devices which are arranged on two stages vertically. Since the lower conveyance device has the same structure as the structure of conveyance device 150 shown in FIGS. 5 and 6, the same symbols and numbers refer to the same members, and the explanations are omitted. Since the upper conveyance device has the conveyance arm which is only one third that of conveyance device 150 shown in FIGS. 5 and 6, only the numerical numbers of the conveyance device are put dashes to distinguish, and another members which are the same as those shown in FIGS. 5 and 6, are put the same numerical numbers and the explanations are omitted. In the condition of FIG. 7, conveyance devices 150 and 150′ align their supporting cylinders 152 one above the other.

As shown in FIG. 7, upper conveyance device 150′ is fixed so that supporting cylinder 152 is arranged under supplying outlet 201 of glass material supplying section 200, while movable lower conveyance device 150 is arranged so that supplying cylinder 152 becomes aligned with the center line of the supplying cylinder of upper conveyance device 150′. Glass material supplying section 200 is composed of melting furnace 202 for melting the glass material to the fluid or semi-fluid condition, heater 202 arranged around melting furnace 201, and blade 203 for agitating glass material LG melted in melting furnace 202.

The procedure of the present embodiment will be described as follows. After shutter members 154 of both conveyance devices 150′ and 150 are closed, glass material PF (the preferable volume of which is less than 100 mm³), which has been heated and melted at a temperature higher than the softening point, is dropped from nozzle 201a, which is provided at the bottom of melting furnace 201 of glass material supplying section 200 (a step of discontinuous drops), then glass material PF enters supporting cylinder 152 of upper conveyance device 150′, and glass material can be maintained in the spherical shape and can be supported in a non-physical contact condition, while the temperature of the glass material is controlled as desired. After the predetermined time period has passed, shutter member 154 is moved to the open position so that glass material PF will be dropped, and is received by supporting cylinder 152 of lower conveyance device 150 which is arranged just below upper conveyance device 150′, and the glass material can be supported continuously in the non-physical contact, and at a temperature controlled condition. By the above procedure, glass material PF is cooled to the predetermined temperature (being higher than the transition point, 400° C., for example).

Then shutter member 154 of upper conveyance device 150′ is closed immediately, heated and molten glass material PF is dropped into supporting cylinder 152, and glass material PF is supported in the temperature controlled and non-physical contact floating condition. When the predetermined time period has passed after glass material PF is delivered to the lower conveyance device 150, lower conveyance device 150 is moved so that the center of supporting cylinder 152 is aligned with the center of press molding dies 1 and 2 (FIG. 4) which have been previously set to the predetermined temperature. Next shutter member 154 is opened to drop molten and softened glass material PF, so that glass material PF is placed into the predetermined position, immediately after which, shutter member 154 is closed, and lower conveyance device 150 returns to its former position under upper conveyance device 150′. As soon as conveyance device 150 returns, press molding dies 1 and 2 (FIG. 4) approach each other, and begin the pressing operation (being a step for molding), and thereby, glass material PF is formed and is subjected to enter the annealing process. Accordingly, the present embodiment can receive and cool the melted glass material which drops at short time intervals, using conveyance device 150′, and can perform the molding process. Therefore, compared to the case in which conveyance device 150′ is not used, the present embodiment can produce extremely high accurate optical elements in one half tact.

In the present embodiment, switching from floating support to dropping of glass material PF is performed by the opening/closing operation of the shutter member, however, it is also possible to perform the switching by changing the supply of gas pressure, instead of providing the shutter member as another embodiment.

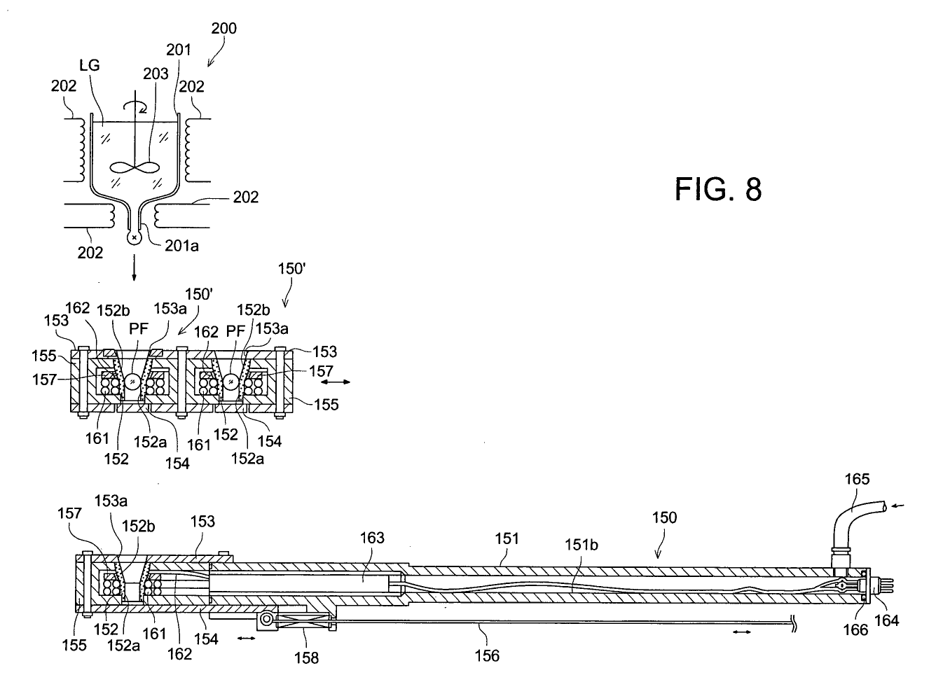

FIG. 8 is a sectional view of the conveyance system of the second embodiment. This conveyance system is composed of conveyance devices which are aligned in two stages vertically, the same way as the embodiment shown in FIG. 7. Two sets of conveyance devices are arranged horizontally on the upper stage, and can be moved under nozzle 201a (that is the same as the one shown in FIG. 7) of glass material supplying section 200. Since the lower conveyance device is structured in the same manner as conveyance device 150 shown in FIGS. 5, 6, or 7, the same numerals are used for the same members, and the respective explanations are omitted. On the other hand, since two identical conveyance devices are arranged on the upper stage in such a way that conveyance device 150′ shown in FIG. 7 is rotated 90° on the center of the through hole on the upper stage, the same numerals are used for the same members, and the respective explanations are omitted. In the condition shown in FIG. 8, both conveyance devices 150′ of the upper stage are arranged so that their supporting cylinders 152 are arranged parallel to each other.

In the condition shown in FIG. 8, there are three sets of conveyance devices, and after shutter members 154 of respective conveyance devices 150′, and 150 are closed, melted glass material is dropped from nozzle 201a of glass material supplying section 200, that is, a single glass material PF in a high temperature is dropped into supporting cylinder 152 of left conveyance device 150′ of the upper stage. Next, two upper conveyance devices 150′ are moved as a single unit to left in the figure, when the predetermined time interval has passed after glass material PF is dropped into left upper conveyance device 150′, melted glass material PF is dropped from nozzle 201a of glass supplying section 200, that is, a single glass material PF in high temperature is dropped into supporting cylinder 152 of the right upper conveyance device 150′.

After that, both conveyance devices 150′ are integrally moved toward the right in the figure, resulting the condition shown in FIG. 8. When the predetermined time interval has passed after glass material PF is dropped in left upper conveyance device 150′ on the upper stage, shutter member 154 are moved to the open position to drop glass material PF, and glass material PF is received by supporting cylinder 152 of conveyance device 150 of the lower stage which is previously positioned just under supporting cylinder 152 of right conveyance device 150 of the upper stage, and then glass material PF is supported in the temperature controlled and non physical contact floating condition.

Further, shutter member 154 of left conveyance device 150′ of the upper stage is then immediately closed, a single molten glass material PF is dropped into supporting cylinder 152, and glass material PF is supported in the temperature controlled and non physical contact floating condition. Conveyance device 150 of the lower stage which has received glass material PF, is moved onto the center of the press molding die, which was previously maintained at a set temperature, so that the center of supporting cylinder 152 is positioned at the center of the molding die. Then shutter member 154 is opened to drop cooled glass material PF, and glass material PF is placed onto the predetermined position, next shutter member 154 is immediately closed, and finally, conveyance device 150 of the lower stage returns just under right conveyance device 150′ of the upper stage, as shown in FIG. 8.

As soon as conveyance device 150 has returned, the molding press dies (not illustrated) begin the molding operation to mold glass material PF, and then perform the annealing process. Before next glass material PF is dropped, the molding dies open to expel the newly formed molded optical element, and the molding dies enter the stand-by condition with the die open.

As shown in FIG. 8, when conveyance device 150 of the lower stage returns, the predetermined time interval has passed since glass material PH was dropped into right conveyance device 150′ of the upper stage. Due to this, glass material PF, cooled for the predetermined time interval in conveyance device 150′ of the upper stage, is dropped as soon as conveyance device 150 of the lower stage is correctly positioned, and finally, glass material PF is received by conveyance device 150 of the lower stage. By performing the above-mentioned operations, glass material PF is received and cooled by upper conveyance devices 150′, and is delivered to lower conveyance device 150 at predetermined intervals. Accordingly, it is possible to reduce the tact of the press molding to one third, compared with the case in which dual conveyance devices 150′ are not used.

In a series of the operation mentioned above, the dropping position of the glass material PF from nozzle 201a, and the glass material PF receiving position of the conveyance device of the lower stage, are determined by the relative positional relationship to conveyance device 150′ of the upper stage. Accordingly, instead of the above-mentioned embodiment, it is also possible to structure a system in which the conveyance device of the upper stage is fixed, and the supplying outlet of the glass material and the conveyance device 150 of the lower stage are moved, and further, the glass material is transferred under both supporting cylinders 152 of conveyance devices 150′ of the upper stage. Further, when a plurality of stages of the conveyance device are provided, different types of fluids and different setting temperature can be used for each set of conveyance device.

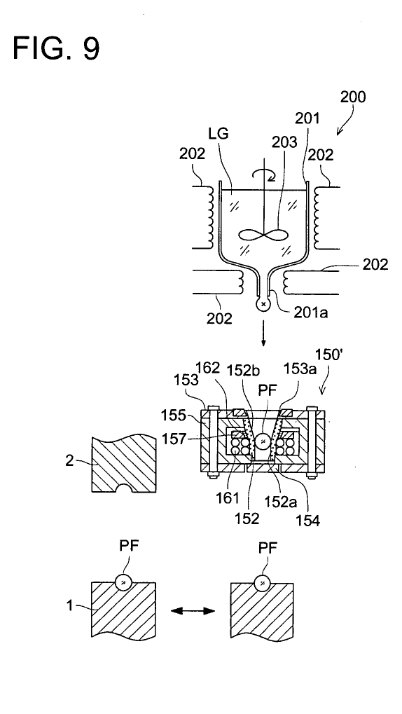

As mentioned above, the present invention has been explained referring to the embodiments, but the invention should not be interpreted to be limited to the above-mentioned embodiments, and needless to say, it is possible to appropriately modify and to improve the embodiments. For example, as shown in FIG. 9, conveyance device 150′ can be fixed, and lower molding die 1 is moved to a delivery position (which is a supplying outlet) below conveyance device 150′, where the glass material is delivered to lower molding die 1, and lower molding die 1 is moved to the molding position which is below upper molding die 2 to perform molding. Further the present invention is not limited to use the glass material, but a plastic material could also be used instead.

According to the present invention, it is possible to offer the conveyance device, the manufacturing apparatus of the optical element, and the manufacturing method of the optical element wherein the heated and melted glass material in a fluid condition can be conveyed while being cooled.

What is claimed is:

1. A conveyance apparatus, comprising:
a supporting device having a through hole passing in a gravity direction, to support a glass material in a fluid or semi-fluid condition; and
a supplying device to supply a fluid into the through hole;
wherein when the glass material is dropped into the through hole from a top of the through hole, the glass material is supported by the fluid in the through hole, under a non-physical contact condition, and when the glass material is not supported by change of the amount of supply of the fluid, the glass material drops from a lower end of the through hole to an outside.

2. The conveyance apparatus of claim 1,
wherein the temperature of the glass material is controlled by the fluid supplied from the supplying device, when the fluid comes into contact with the glass material.

3. The conveyance apparatus of claim 1, further comprising:
a temperature control device for controlling the temperature of the fluid supplied to the through hole.

4. The conveyance apparatus of claim 3,
wherein the temperature control device has a heater and a thermal sensor which are arranged in a supplying path of the fluid.

5. The conveyance apparatus of claim 1,
wherein the fluid is supplied into the through hole in such a way that the fluid passes between the glass material and an interior wall of the through hole.

6. The conveyance apparatus of claim 1, further comprising:
a shutter member which is located lower in the vertical direction than a position through which the fluid is supplied into the through hole, and is movable between a position for closing at least a portion of the through hole, and a position for opening the through hole.

7. The conveyance apparatus of claim 1,
wherein the glass material is an optical glass.

8. The conveyance apparatus of claim 1,
wherein the temperature of the fluid supplied into the through hole is lower than the temperature of the glass material at the moment when the glass material is dropped into the through hole, and higher than the transition point of the glass.

9. The conveyance apparatus of claim 8,
wherein when the glass material is dropped into the through hole, the temperature of the fluid supplied into the hole is set higher than the softening point of the glass material, and after that, the temperature of the fluid is set lower than the softening point plus 100° C., and is always higher than the transition point of the glass material.

10. The conveyance apparatus of claim 8,
wherein when the fluid is supplied into the through hole, the temperature of the fluid is set lower than the softening point of the glass material plus 100° C., and is always higher than the transition point of the glass material.

11. The conveyance apparatus of claim 1,
wherein the glass material dropped from the conveyance apparatus is supplied to a molding die of a molding device.

12. The conveyance apparatus of claim 11,
wherein the glass material is molded by the molding die of the molding device, and becomes an optical element.

13. The conveyance apparatus of claim 1,
wherein the glass material to be dropped is less than 100 mm³.

14. The conveyance apparatus of claim 1,
wherein the transition point of the glass material is lower than 400° C.

15. The conveyance apparatus of claim 1,
wherein a tapered section which increases in diameter from its base to its top is provided on a top section of the through hole.

16. The conveyance apparatus of claim 1,
wherein a porous material is arranged on a portion of an inner circumferential surface of the through hole, and through which the fluid is supplied to the through hole.

17. The conveyance apparatus of claim 1,
wherein the porous material is a graphite.

18. A manufacturing apparatus of an optical element, comprising:
a supporting device having a through hole passing in a gravity direction, to support a glass material in a fluid or semi-fluid condition;
a supplying device to supply a fluid into the through hole; and
paired molding dies, one of which performs relative displacement with the other between an receptive position in which both of the dies are separated and an adjacent position at which the glass material is molded;
wherein when the glass material is dropped into the through hole from a top of the through hole, the glass material is supported under a non-physical contact condition by the fluid in the through hole, and when the glass material is not supported by change of the amount of supply of the fluid, the glass material drops from a lower end of the through hole into one of the molding dies which is in the receptive position, and then the glass material is formed into an optical element.

19. The manufacturing apparatus of the optical element of claim 18,
wherein the temperature of the glass material is controlled by the fluid supplied from the supplying device, when the fluid comes into contact with the glass material.

20. The manufacturing apparatus of the optical element of claim 18, further comprising:
a temperature control device for controlling the temperature of the fluid supplied into the thorough hole.

21. The manufacturing apparatus of the optical element of claim 20,
wherein the temperature control device has a heater and a thermal sensor which are arranged in a supplying path of the fluid.

22. The manufacturing apparatus of the optical element of claim 18,
wherein the fluid is supplied into the through hole in such a way that the fluid passes between the glass material and an interior wall of the through hole.

23. The manufacturing apparatus of the optical element of claim 18, further comprising:
a shutter member which is located lower in the vertical direction than a position through which the fluid is supplied into the through hole, and is movable between a position for closing at least a portion of the through hole, and a position for opening the through hole.

24. The manufacturing apparatus of the optical element of claim 18,
wherein the glass material is an optical glass.

25. The manufacturing apparatus of the optical element of claim 18,
wherein the temperature of the fluid supplied into the through hole is lower than the temperature of the glass material at the moment when the glass material is dropped into the through hole, and higher than the transition point of the glass.

26. The manufacturing apparatus of the optical element of claim 25,
wherein when the glass material is dropped into the through hole, the temperature of the fluid supplied into the hole is set higher than the softening point of the glass material, and after that, the temperature of the fluid is set lower than the softening point plus 100° C., and is always higher than the transition point of the glass material.

27. The manufacturing apparatus of the optical element of claim 25,
wherein when the fluid is supplied into the through hole, the temperature of the fluid is set lower than the softening point of the glass material plus 100° C., and is always higher than the transition point of the glass material.

28. The manufacturing apparatus of the optical element of claim 18,
wherein the glass material to be dropped is less than 100 mm³.

29. The manufacturing apparatus of the optical element of claim 18,
wherein the transition point of the glass material is lower than 400° C.

30. The manufacturing apparatus of the optical element of claim 18,
wherein a tapered section which increases in diameter from its base to its top is provided on a top section of the through hole.

31. The manufacturing apparatus of the optical element of claim 18,
wherein a porous material is arranged on a portion of an inner circumferential surface of the through hole, and through which the fluid is supplied to the through hole.

32. The manufacturing apparatus of the optical element of claim 31,
wherein the porous material is a graphite.

33. A manufacturing method of an optical element, comprising:
a step of vertically dropping a glass material being heated and in a fluid or semi-fluid condition into a supporting a supporting device, having a through hole passing in a gravity direction;
a step of supplying a fluid into the through hole by a supplying means;
a step of supporting the dropped glass material against the force of gravity, under a non-physical contact except for the fluid which is supplied into the through hole;
a step of dropping the glass material into a molding die from a bottom of the through hole, by stopping the supply of the fluid, or reducing the amount of supply of the fluid; and
a step of forming the dropped glass material into an optical element by the molding dies.

34. The manufacturing method of the optical element of claim 33, further comprising:
a step of controlling the temperature of the fluid supplied by the supplying means,
wherein the temperature of the glass material is controlled by the fluid supplied from the supplying device, when the fluid comes into contact with the glass material.

35. The manufacturing method of the optical element of claim 34,
wherein the temperature of the glass material when the glass material is dropped into the through hole, is higher than the temperature of the glass material when the glass material is dropped into the molding die.
